(19) United States
(12) Patent Application Publication
(10) Pub. No.: US 2009/0039062 A1
(43) Pub. Date: Feb. 12, 2009

(54) TORCH BRAZING PROCESS AND APPARATUS THEREFOR

(75) Inventors: Laurent Cretegny, Niskayuna, NY (US); Jeffrey Reid Thyssen, Salem, MA (US); John Ralph Campbell, Cheshire, MA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/834,528

(22) Filed: Aug. 6, 2007

(51) Int. Cl. B23K 1/00; B23K 31/02

(52) U.S. Cl. 219/129; 228/219

(57) ABSTRACT

A process and apparatus for brazing a metal alloy component, such as a superalloy component of a gas turbine engine. The process employs a plasma torch in a non-transferred arc mode to generate an electric arc between an electrode and a housing in which an orifice is defined. A plasma gas is flowed through the arc so as to ionize the plasma gas, and the resulting ionized plasma gas is discharged through the orifice to form a plasma jet. The plasma torch is configured so that the plasma jet is shrouded from a surrounding oxidizing atmosphere by a shielding gas flowing cocurrently with the plasma jet. A braze alloy material is introduced into the plasma jet, which is directed at a surface of the component to form a brazement that is metallurgically bonded to the component without melting the component.

### BACKGROUND OF THE INVENTION

The present invention generally relates to methods for brazing metal alloys, particularly those suitable for use in the high temperature environment of a gas turbine engine. More particularly, this invention relates to a torch brazing process and apparatus capable of performing a controlled braze repair of components, including those formed of directionally solidified (DS) and single-crystal (SX) superalloys.

Hot section components of gas turbine engines, such as blades (buckets), vanes (nozzles) and combustors, are typically formed of nickel, cobalt and iron-base superalloys characterized by desirable mechanical properties at turbine operating temperatures. These components are typically used in cast form, and as a result can have point defects, e.g., ceramic inclusions, pores, etc., as well as small linear defects that require repair. Cracks and other damage can also occur with these components during service. Various welding techniques have been developed that are capable of repairing defects and damage to superalloys, including tungsten inert gas (TIG) and plasma transferred arc (PTA) welding processes performed with an inert shielding gas, such as argon. TIG and PTA welding involve the use of a welding torch, and must be carefully carried out to achieve acceptable welding yields and ensure that the mechanical properties of the superalloy are maintained. An example of a PTA welding process is disclosed in U.S. Pat. No. 4,878,953 to Saltzman et al. As is the case with PTA welding processes, the plasma torch employed by Saltzman et al. is operated in the “transferred arc” mode, in which the welding arc is between the torch electrode and the substrate being repaired, resulting in intentional localized melting of the substrate. Another example of a PTA welding process is disclosed in U.S. Published Patent Application No. 2005/0015980A1 to Kottilingam et al. Because welding involves melting and depositing a filler alloy on a base alloy that is itself is locally melted, the melted portion of the base alloy undergoes resolidification at the conclusion of the welding process. As a result, alternative methods have been developed to repair directionally solidified (DS) and single-crystal (SX) superalloys, whose microstructures must remain substantially unchanged in order to retain the desired properties for the component. An example of such a process is torch brazing, which makes limited localized heating and brazing of an alloy possible. If performed in air or another oxidizing atmosphere, the use of a flux compound is required to remove oxides from the surfaces being brazed. However, the use of fluxes to repair highly critical gas turbine engine components is undesirable, because flux particles may become entrapped in the brazement, with the potential for severely affecting the properties of the component.

As an alternative to torch brazing processes that require the use of a flux, fluxless brazing processes exist that entail applying a braze alloy to the surface requiring repair, and then heating the entire component in a vacuum or inert gas furnace to minimize the formation of oxides and promote wetting of the base metal by the braze alloy. However, heating the entire component results in very long costly brazing cycles, and the sustained high temperatures may adversely affect the mechanical and corrosion-resistance properties of the component.

In view of the above, it would be desirable if a process were available for repairing high-temperature superalloys, by which melting of the base metal is substantially avoided. It also be desirable if such a process could be performed in atmospheric air, yet without the use of fluxes to reduce cost and minimize detrimental changes in the mechanical and corrosion-resistance properties of the base metal.

### BRIEF SUMMARY OF THE INVENTION

The present invention provides a process and apparatus for brazing a metal alloy component, such as a superalloy component of a gas turbine engine. The process employs a plasma torch in a non-transferred arc mode to generate an electric arc within the plasma torch between an electrode and a housing in which an orifice is defined. A plasma gas is flowed through the electric arc so as to be ionized, and the resulting ionized plasma gas is discharged through the orifice to form a plasma jet. The plasma torch is configured so that the plasma jet is shrouded from a surrounding oxidizing atmosphere by a shielding gas flowing cocurrently with the plasma jet. While the arc continues to be generated between the electrode and the housing, a braze alloy material is introduced into the plasma jet, which is directed at a surface of the component to form a brazement that is metallurgically-bonded to the component without melting the component and without generating an electric arc between the electrode and the substrate.

According to a preferred aspect of the invention, and in part as a result of being operated in a non-transferred arc mode, the plasma torch is capable of performing manual brazing of metal alloys, in particular advanced alloys such as directionally solidified (DS) and single crystal (SX) superalloys, and therefore provides considerable flexibility to the manufacture, repair, and rework of components formed from such alloys at a fraction of the cost required to perform the same task in a vacuum furnace. Other preferred and notable aspects of the invention include the use of relatively high arc currents, anode and cathode materials capable of sustaining the relatively high arc currents, the use of plasma gases with high energetic properties to enhance the heating and oxide-reducing effect of the plasma jet, and the use of high shielding gas flow rates to provide shielding of the plasma jet.

Other objects and advantages of this invention will be better appreciated from the following detailed description.

### BRIEF DESCRIPTION OF THE DRAWINGS

FIG. 1 schematically represents a plasma torch suitable for use in a torch brazing process of this invention.

FIG. 2 is a detailed view of the lower end of the plasma torch of FIG. 1 during the repair of a defect in a surface of a component.

FIGS. 3, 4 and 5 are scanned images of photomicrographs showing superalloy specimens repaired by a torch brazing process of this invention.

### DETAILED DESCRIPTION OF THE INVENTION

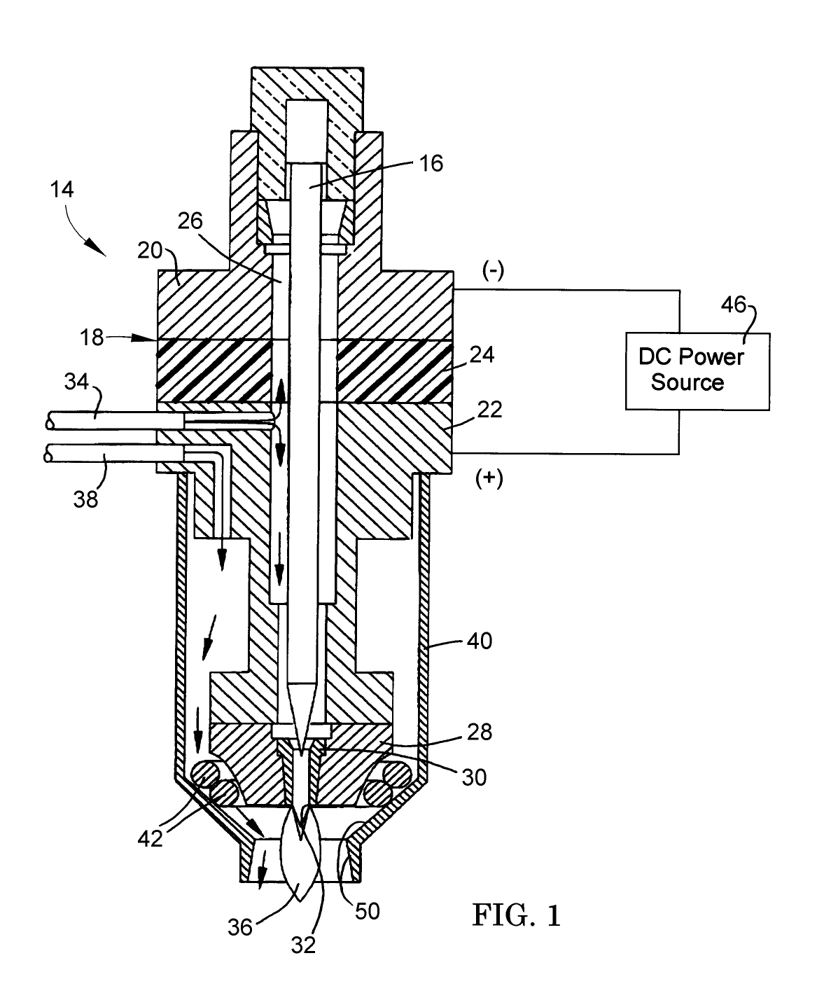

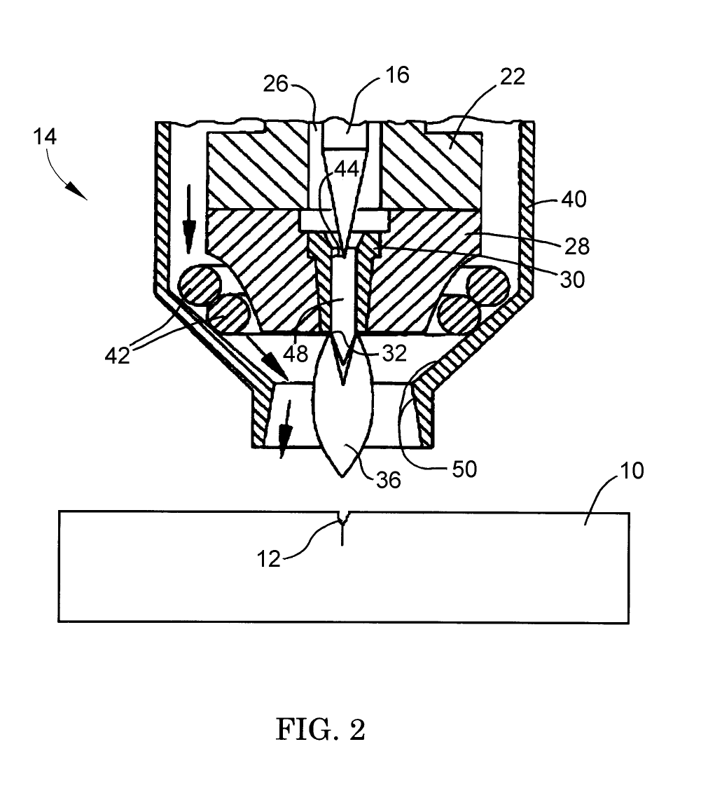

FIGS. 1 and 2 represent a brazing torch 14 (FIG. 1) and the use of that torch 14 to repair a component 10 having a surface defect 12 (FIG. 2). The component 10 may be formed of a variety of metal alloys, including those that are relatively difficult to weld and braze, such as nickel, cobalt and iron-based superalloys used to form cast or forged components of gas turbine engines. If the component 10 is a casting, the defect 12 may be a point defect, such as a ceramic inclusion, pore, etc., or a linear defect. The defect 12 may also be a crack, erosion, or other flaw resulting from in-service damage to the component 10.

As represented in FIGS. 1 and 2, the torch 14 is a plasma torch and has an electrode 16 within a housing 18, which in turn is an assembly that includes two electrically conductive housing members 20 and 22 separated by an insulator 24. As is common with electrodes for PTA welding torches, the electrode 16 is preferably formed of tungsten, preferably a tungsten alloy in which tungsten is alloyed with thorium, lanthanum, or copper. The housing members 20 and 22 are preferably though not necessarily formed of copper or a copper alloy, while the insulator 24 is preferably though not required to be formed of TEFLON® (polytetrafluoroethylene, or PTFE). The electrode 16 is suspended within a passage 26 within the housing 18, and electrically coupled to only the upper housing member 20. The lower end of the electrode 16 is disposed within an orifice housing 28 mounted at the lower end of the lower housing member 22. A conduit 34 is shown as supplying a gas to the passage 26, which exits the passage 26 and the housing 18 through an orifice 32 define by a replaceable insert 30 within the orifice housing 28. As will be discussed below, the gas flowing through the passage 26 and orifice 32 is used by the torch 14 to form a high-velocity plasma flame or jet 36, and therefore will be referred to as the plasma gas. A second conduit 38 supplies a shielding gas to an annular passage defined by and between the lower housing member 22 and an outer shield cup 40. The plasma jet 36 is shrouded within the shielding gas, which flows cocurrently with the plasma jet 36, i.e., roughly parallel and in the same direction. As will be discussed in more detail below, the shield cup 40 is configured to discharge the shielding gas around the plasma jet 36 to prevent oxidation of the surfaces of the defect 12 and the adjacent surfaces of the component 10 during the torch brazing operation.

The plasma torch 14 of this invention is operated in a non-transferred arc mode. As more readily evident from FIG. 2, the non-transferred arc mode entails generating and maintaining an electric (pilot) arc 44 between the electrode 16 and the orifice housing 28, and more specifically the insert 30 of the orifice housing 28. A welding arc associated with plasma transferred arc (PTA) welding is not generated or even desired between the electrode 16 and the component 10. The pilot arc 44 is generated by imposing opposite polarities on the upper housing member 20 (and its electrode 16) and the lower housing member 22, including its orifice housing 28 and insert 30, both of which are therefore required to be electrically conductive. The upper housing member 20 and electrode 16 are preferably the cathode of the electric circuit that generates the pilot arc 44, while the lower housing member 22, orifice housing 28, and insert 30 preferably serve as the anode. A DC power supply 46 is connected to the housing members 20 and 22 by any suitable means to provide the welding current necessary to establish the pilot arc 44 between the electrode 16 and insert 30.

As shown in FIGS. 1 and 2, the electrode 16 and an orifice passage 48 defined by the insert 30 have generally cylindrical shapes, but with the lowermost portion of the electrode 16 and the uppermost portion of the orifice passage 48 being tapered. The cylindrical portion of the electrode 16 and the opening to the orifice passage 48 may have the same diameter, for example, about 0.1875 inch (about 4.7625 mm). The tapered portion of the electrode 16 projects through the tapered portion of the orifice passage 48 and extends into but not entirely through the cylindrical portion of the passage 48. The lower extremity of the electrode 16 is recessed within the insert 30 a distance, referred to as the depth setting, from the orifice 32 at the lower extremity of the insert 30. Based on investigations with a plasma torch 14 and components as described herein, a depth setting of about 0.125 inch (about 3.175 mm) has been successfully used, though greater and less depths are also within the scope of this invention. The tapered portions of the electrode 16 and orifice passage 48 are sized and shaped to define an annular gap through which the plasma gas flows. The shape of the annular gap is not believed to be critical, it preferably defines a continuous and uniform radial gap of about 0.016 to about 0.030 inch (about 0.41 to about 0.76 mm) between the electrode 16 and insert 30. Because the electrode 18 and orifice passage 48 taper in the same direction, the depth setting of the electrode 16 relative to the orifice 32 can be used to control the current required to initiate and sustain a stable pilot arc 44. With the plasma gas flow rate, which is preferably adjusted by controlling the inlet pressure to the conduit 34, the amperage level of the pilot arc 44 can be used to control the total heat output of the plasma jet 36 produced by the plasma torch 14.

Though not shown, the plasma torch 14 can be used in combination with a device for delivering a suitable braze alloy material to the plasma jet 36, which melts and propels the braze alloy material toward the defect 12 in the component 10. Depending on the form of the braze alloy material, the delivery device can be conventionally adapted to deliver the braze alloy material at controllable rates. According to a preferred aspect of the invention, the braze alloy material is in the form of a wire or rod, though it is foreseeable that a braze alloy powder could be used. A controller (not shown) can be connected to the power supply 46 and the braze alloy delivery device to synchronize their operations.

As known in the art, the plasma gas is ionized by the pilot arc 44, through which the plasma gas passes before being discharged through the orifice 32. Rapid heating and ionization causes the ionized plasma gas to expand and exit the orifice 32 at a high velocity. The shielding gas surrounds the resulting plasma jet 36 to protect the molten braze alloy before and after its deposition, and also protect the surrounding surfaces of the component 10, from contamination and oxidation by the surrounding atmosphere.

Though it is not generally pertinent to make a comparison of the operating conditions for the non-transferred arc mode (in which an arc is only used to ionize a gas) employed by the present invention to perform a brazing operation (in which only a braze alloy is melted) and those of standard plasma transferred-arc welding (in which an arc is maintained between a torch and a substrate) to perform a welding operation (in which the substrate is intentionally melted), it may nonetheless be noted that relatively low amperages are typically employed (e.g., less than 50 amperes as taught in U.S. Published Patent Application No. 2005/0015980A1 to Kottilingam et al.) in plasma transferred-arc welding to minimize melting, distortion and adverse affects on the substrate being repaired, whereas the plasma torch 14 of this invention is preferably operated at relatively high amperages, preferably at least 50 amperes, for example, about 50 to about 120 amperes. As such, the power supply 46 used with the torch 14 is preferably capable of providing an arc discharge having a voltage of, for example, about 35 volts. At such high amperage and power levels, the torch 14 generates a high intensity plasma jet 36 capable of melting a braze alloy and locally heating, but not melting, high temperature, high-strength, corrosion-resistant superalloys, including those containing significant amounts of elements such as chromium, titanium, aluminum, molybdenum, and niobium that render superalloys difficult to wet in air without the use of fluxes, vacuum systems, or closed inert chambers. When operated in the non-transferred arc mode (pilot mode), the plasma torch 14 enables significant control of the process temperature and enables brazing of single-crystal components without incipient melting or recrystallization of the base metal.

The above-noted capabilities of the plasma torch 14 are also in part attributable to the insert 30, the shield cup 40, and the types and flow rates of the plasma and shielding gases. Because the arc 44 is maintained between the electrode 16 and insert 30, the electrode 16 and insert 30 are prone to erosion. Erosion of the electrode 16 is reduced as a result of being formed of tungsten or a tungsten alloy, as noted above. The insert 30 is also preferably formed of tungsten or a tungsten alloy (for example, W—Th, W—La, or W—Cu alloys, such as W-10Cu and W-20Cu alloys) in order to operate at and withstand the high amperages and temperatures desired for the torch 14 with minimum erosion of the insert 30 and its orifice 32.

The use of higher continuous current amperes to generate the pilot arc 44 is preferably combined with a plasma gas having highly energetic properties. For this reason, a preferred plasma gas is a mixture of helium and hydrogen at a volumetric ratio of at least about 99:1, with higher hydrogen levels being desirable to provide a reducing atmosphere capable of enhancing the brazing process. An upper limit of about 4% hydrogen may be used as it is below the lower explosive limit (LEL) of hydrogen. However, a mixture of He-5% H₂ was found to be particularly desirable in combination with pilot arc amperages of about 50 to about 65 amperes, particularly about 53 amperes. Still higher hydrogen contents are foreseeable if appropriate safety features are in place (e.g., a system that excludes oxygen from the location of the torch). Suitable flow rates for the plasma gas are about 3 to about 30 liters per minute (l/min). More preferred flow rates are about 10 to about 20 l/min, particularly about 15 l/min.

The shield cup 40 is configured to accommodate high flow rates of an effective shielding gas, such as rates of about 10 to about 55 l/min, preferably about 18 to about 30 l/min, most preferably about 23 l/min, using argon or a mixture of argon and hydrogen. To accommodate such high flow rates, the interior portion of the shield cup 40 immediately downstream of the orifice 32 is configured to define a passage 50 through which the shielding gas flows to form a protective laminar flow around the helium/hydrogen plasma jet 36, so that the jet 36 is completely contained within a continuous shroud of shielding gas and the flow of the jet 36 is not detrimentally affected by the shielding gas. Diffuser rings 42 are located within the lower end of the shield cup 40, and are shown as being sized and shaped (annular with round cross-section) to promote a uniform, non-turbulent gas flow through the passage 50, whose converging-diverging shape also promotes laminar flow of the shielding gas around the plasma jet 36. To withstand the conditions within the shield cup 40 adjacent the orifice housing 28, the diffuser rings 42 are preferably formed of copper or a copper alloy. By providing a laminar shielding gas flow at high flow rates, the shielding gas effectively minimizes oxidation of the braze alloy and the surface of the component 10 subjected to heating by the plasma jet 36, thereby allowing localized heating and brazing of the superalloy component 10 to occur even if the plasma torch 14 is operated in an oxidizing (e.g., air) environment. Suitable plasma gas and shielding gas distribution systems minimize the adsorption of water vapor and oxygen while maintaining levels of such impurities preferably below 5 ppm.

The braze filler material is preferably fed to the plasma jet 36 in the form of a braze wire or rod. For brazing nickel-based superalloys, braze rods are preferably formed from a nickel-based braze powder in a non-oxidizing atmosphere, so that the rods do not contain oxides of the braze alloy constituents (e.g., chromium, titanium, aluminum, etc.). A particularly suitable method for manufacturing a braze rod is to place a powder of the desired braze alloy in a V-shaped groove of a high density, 99% pure alumina mold, and then melting the powder at a temperature between the solidus and liquidus points of the braze alloy. An example of a suitable braze alloy is commercially known as B93, with a composition (by weight) of about 0.13-0.19% carbon, about 13.7-14.3% chromium, about 9.0-10.0% cobalt, about 4.6-5.2% titanium, about 2.8-3.2% aluminum, about 0.5-0.8% boron, about 4.2-4.8% silicon, and the balance nickel and incidental impurities. However, the invention is not limited to any particular braze alloy, and other braze alloys could be used.

Though not required, braze rods employed by this invention may be provided with a solid flux coating to enhance the environmental protection of the brazing process by providing additional oxide-reducing power and by promoting wetting of the component 10 by the molten braze alloy. Preferred solid fluxes are those capable of melting and decomposing during the brazing process to leave no solid residues, and instead form gaseous products that can freely escape prior to solidification of the brazement. Notable examples of solid fluxes with these characteristics include potassium fluoride, cesium fluoride, lithium fluoride, and aluminum fluoride as fluoroaluminum complexes. Particular examples include potassium fluoroaluminate complexes such as potassium tetrafluoroaluminate (KAIF4), potassium fluoroborate complexes such as potassium tetrafluoroborate (KBF4), and cesium fluoroaluminate complexes such as cesium tetrafluoroaluminate (CsAIF4). These flux compounds may be combined with a binder capable of cleanly burning off in the plasma jet 36. The resulting mixture, preferably in the form of a paste, can be applied to form a coating on the exterior surface of a braze rod. Suitable amounts for the flux are believed to be, by weight, up to about 10%, preferably not more than about 5%, and more preferably not more than 2% of the total weight of the rod.

A suitable brazing process employing the plasma torch 14 described above generally entails bringing the torch 14 into proximity with the surface of the component 10, which is schematically depicted in FIG. 2 though not to scale. As known in the art, prior to brazing the surfaces of the defect 12 and the adjacent surfaces of the component 10 preferably undergo a surface treatment to remove any oxides, corrosion products, oils, greases, and any other surface contaminants that could interfere with the brazing operation. Suitable standoff distances are believed to be about 0.5 to about 1.5 inch (about 10 to about 40 mm) between the component surface and the lower end of the shield cup 40, with lesser and greater distances being foreseeable in view of plasma intensity and operator skill being factors for an optimum standoff distance. The brazing process is then performed by initiating flow of the plasma and shielding gases, operating the power supply 46 to generate the pilot arc 44 between the lower extremity of the electrode 16 and the immediately adjacent surface of the insert 30, and then feeding the desired braze alloy material into the resulting plasma jet 36. The torch 14 is operated only for the extent necessary to fill the defect 12 and coat the immediately surrounding surfaces of the component 10, after which the component 10 is allowed to cool in accordance with known practices. Also in accordance with conventional practices, the component 10 may undergo a heat treatment, after which the brazement and the surface of the component 10 can be further conditioned as may be desired or necessary.

In view of the above, it can be appreciated that the repair process of this invention and its non-transferred plasma torch 14 provide a desirable combination of heat input and control with gas shielding capability, while allowing repair procedures to be performed with low cost capital equipment investment. The process can be performed in a standard air environment without the use of special furnace equipment and fixtures, resulting in significantly lower repair costs at a faster turnaround time. The process also enables the rework of brazed components without having to perform an additional braze cycle on the entire component. In addition to repairs, the brazing process can also be used to join or repair metallic coatings, such as corrosion-resistant coatings applied to superalloy turbine components.

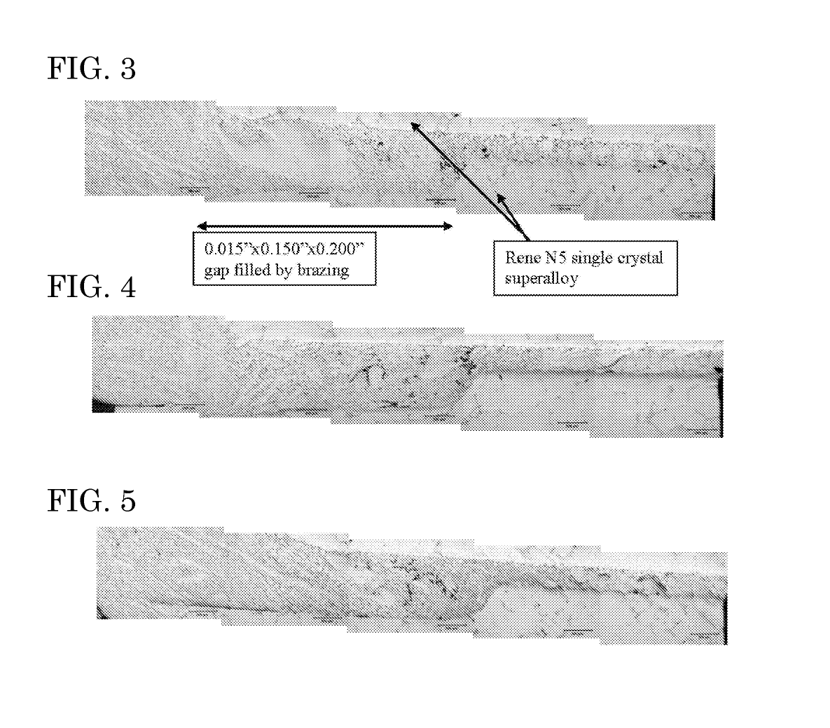

In an investigation leading up to the invention, the feasibility of using a manually positioned and manipulated plasma non-transferred arc torch brazing process to form a repair brazement on a superalloy substrate was demonstrated on single-crystal coupons formed of a gamma prime-strengthened nickel-base superalloy commercially known under the name Rene N5 (U.S. Pat. No. 6,074,602) and having a nominal composition of, by weight, about 7.5% Co, 7.0% Cr, 6.5% Ta, 6.2% Al, 5.0% W, 3.0% Re, 1.5% Mo, 0.15% Hf, 0.05% C, 0.004% B, 0.01% Y, the balance nickel and incidental impurities. The coupons were formed to have gaps with dimensions of about 0.015×0.150×0.200 inch (about 0.38×3.8×5.1 mm). The braze alloy was in the form of a rod whose composition was the aforementioned B93 braze alloy, with a liquidus temperature of about 2100° F. (about 1100° C.). The plasma torch was configured similar to the torch 14 of FIGS. 1 and 2, and its operating parameters included the following: standoff distance of about 0.75 inch (about 19 mm); power supply amperage of about 53 amperes; a plasma gas mixture of helium and hydrogen at volumetric ratio of about 95:5; a plasma gas flow rate of about 14.8 l/min; a shielding gas of argon at a flow rate of about 51 l/min. The brazing operations were performed in atmospheric (air) conditions. FIGS. 3 through 5 show three sections of one coupon specimen, cross-sectioned at about 0.150, 0.200, and 0.250 inch (about 3.8, 5.1, and 6.4 mm) from one end of the specimen. As evident from these microphotographs, the braze alloy was able to completely fill the gaps to form brazements that are free of oxides, corrosion products, and other possible contaminants likely to evolve at the elevated temperature required to melt the braze alloy.

In view the above, the torch brazing process of this invention utilizing a plasma torch operated in non-transferred arc mode was shown to be capable of performing manual brazing of nickel-based superalloy, in particular advanced alloys such as directionally solidified (DS) and single crystal (SX) superalloys, and therefore provides considerable flexibility to the manufacture, repair, and rework of components formed from such alloys at a fraction of the cost required to perform the same task in a vacuum furnace. Other preferred and notable aspects of the invention include a tungsten or tungsten alloy insert 30 at the location where the pilot arc 44 is struck to allow higher currents and form a hotter plasma jet 36, a shield cup 40 configured to provide laminar shielding gas flow at high flow rates around the plasma jet 36 for better protection of the hotter plasma jet with greater oxidation-preventing effect, and the use of a He—H₂ plasma gas with relatively high levels of hydrogen to promote the hotter plasma jet and achieve a greater oxide-reducing effect. The manner of manufacturing braze rods in an inert atmosphere and the use of solid fluxes to enhance braze wetting are also very desirable aspects of the invention.

While the invention has been described in terms of a preferred embodiment, it is apparent that other forms could be adopted by one skilled in the art. Therefore, the scope of the invention is to be limited only by the following claims.

1. A torch brazing process comprising:
operating a plasma torch in a non-transferred arc mode to generate an electric arc within the plasma torch between an electrode and a housing in which an orifice is defined, flowing a plasma gas though the electric arc so as to ionize the plasma gas, and discharging the ionized plasma gas though the orifice to form a plasma jet shrouded from a surrounding oxidizing atmosphere by a shielding gas flowing cocurrently with the plasma jet;
while the electric arc continues to be generated between the electrode and the housing, introducing a braze alloy material into the plasma jet; and
while the electric arc continues to be generated between the electrode and the housing, directing the plasma jet at a surface of a substrate formed of a metal alloy to form a brazement metallurgically bonded to the substrate without melting the substrate and without generating an electric arc between the electrode and the substrate.

2. A torch brazing process according to claim 1, wherein the electric arc is generated by a direct current of at least 50 to about 120 amperes.

3. A torch brazing process according to claim 1, wherein the orifice is defined by a portion of the housing formed of tungsten or an alloy thereof, and the electric arc is generated by and between the electrode and the portion of the housing.

4. A torch brazing process according to claim 1, wherein the plasma gas is a mixture of helium and hydrogen, and wherein the plasma gas flows at a rate of about 3 to about 30 liters per minute though the electric arc.

5. (canceled)

6. A torch brazing process according to claim 1, wherein the plasma gas is a mixture of helium and hydrogen, and wherein the plasma gas contains helium and hydrogen at a volumetric ratio of about 99:1 to about 95:5.

7. A torch brazing process according to claim 1, wherein the shielding gas is argon or a mixture of argon and hydrogen, and wherein the shielding gas flows at a rate of about 10 to about 55 liters per minute.

8. (canceled)

9. A torch brazing process according to claim 1, wherein the shielding gas is argon or a mixture of argon and hydrogen, and wherein the shielding gas exhibits laminar flow around the plasma jet.

10. A torch brazing process according to claim 1, wherein the process is performed without a flux compound.

11. A torch brazing process according to claim 1, wherein the braze alloy material is a rod, and wherein the process is performed without a flux compound.

12. (canceled)

13. A torch brazing process according to claim 1, wherein the braze alloy material is a rod, and wherein the rod has a coating containing a solid flux compound.

14. A torch brazing process according to claim 13, wherein the solid flux is selected from the group consisting of potassium tetrafluoroaluminate, potassium tetrafluoroborate, and mixtures thereof.

15. A torch brazing process according to claim 1, wherein the surrounding oxidizing atmosphere is atmospheric air.

16. A torch brazing process according to claim 1, wherein the metal alloy of the substrate is a superalloy.

17. A torch brazing process according to claim 16, wherein the superalloy is a gamma-prime strengthened single-crystal nickel-base superalloy.

18. A torch brazing process according to claim 17, wherein the substrate is a portion of a gas turbine engine component.

19. A torch brazing process according to claim 1, wherein the process is a repair process in which a defect in the surface of the substrate is filled by the brazement.

20. A torch brazing process according to claim 1, wherein the process is a joining process in which the brazement joins the surface of the substrate to a second surface.

21. A torch brazing apparatus comprising:
a plasma torch having a housing, an insert within the housing and in which a passage terminating at an orifice is defined, an electrode having an end thereof projecting into but not though the passage so as to define an annular gap with the insert;
means for generating an electric arc within the annular gap between the electrode and the insert;
means for flowing a plasma gas though the annular gap and through the electric arc so as to ionize the plasma gas and discharge the ionized plasma gas through the orifice to form a plasma jet; and
means for flowing a shielding gas cocurrently with the plasma jet so that the flow of the shielding gas is laminar and shrouds the plasma jet from a surrounding oxidizing atmosphere.

22. A torch brazing apparatus according to claim 21, wherein the electric arc generating means comprises a direct current of at least 50 to about 120 amperes.

23. A torch brazing apparatus according to claim 21, wherein the insert is formed of tungsten or an alloy thereof.

24. A torch brazing apparatus according to claim 21, wherein the plasma gas is a mixture of helium and hydrogen, and wherein the plasma gas flowing means is adapted to produce a plasma gas flow rate of about 3 to about 30 liters per minute though the electric arc.

25. (canceled)

26. A torch brazing apparatus according to claim 21, wherein the plasma gas is a mixture of helium and hydrogen, and wherein the plasma gas contains helium and hydrogen at a volumetric ratio of about 99:1 to about 95:5.

27. A torch brazing apparatus according to claim 21, wherein the plasma gas is a mixture of helium and hydrogen, and wherein the plasma gas contains helium and hydrogen at a volumetric ratio of at least 95:5.

28. A torch brazing apparatus according to claim 21, wherein the shielding gas is argon or a mixture of argon and hydrogen, and wherein the shielding gas flowing means is adapted to produce a shielding gas flow rate of about 10 to about 55 liters per minute.

29. (canceled)

30. A torch brazing apparatus according to claim 21, wherein the shielding gas is argon or a mixture of argon and hydrogen, and wherein the shielding gas flowing means is configured to induce laminar flow of the shielding gas around the plasma jet.
